(19) United States
(12) Patent Application Publication
(10) Pub. No.: US 2005/0176449 A1
(43) Pub. Date: Aug. 11, 2005

(54) Method and system for simplified access to alerts with a mobile device

(75) Inventors: Yingqing Lawrence Cui, San Jose, CA (US); Zhaowei Jiang, San Jose, CA (US); Min Zhou, Palo Alto, CA (US)

Correspondence Address: DARBY & DARBY P.C., P.O. BOX 5257, NEW YORK, NY, 10150-6257, US

(73) Assignee: Yahoo! Inc., Sunnyvale, CA (US)

(21) Appl. No.: 10/772,532

(22) Filed: Feb. 5, 2004

(51) Int. Cl. H04Q 7/20

(52) U.S. Cl. 455/466; 455/412.2; 455/414.4

(57) ABSTRACT

A method, apparatus, client and server are directed to enabling simplified access to a message with a mobile device. The mobile device is registered with a server to receive the message. In one embodiment, the message is an email message. The message is stored at a location based, in part, on a universal message identifier. The server determines a message index based on the universal message identifier and a device identifier. The server sends a short message, such as SMS message, to the mobile device that includes a message hook. In one embodiment, the message hook is a URL that further includes the message index. If the message hook is selected at the mobile device, the server employs the message index to access the stored message. The accessed message is formatted to be readable by a mobile browser and sent towards the mobile browser.

### FIELD OF THE INVENTION

The present invention relates generally to network messages, and more particularly but not exclusively to providing a simplified access to a Short Message Service (SMS) message.

### BACKGROUND OF THE INVENTION

In today's society, mobile computing devices are becoming increasingly more common. Many mobile computing devices, such as personal digital assistants, cellular phones, and the like, may be employed to communicate brief messages with another computing device, such as a desktop computer, a server, and the like. For example, an end-use user of the mobile computing device may seek to access a short message, such as through Short Message Services (SMS), and the like, from the other computing device.

SMS enables a text message service for short messages, sometimes called alerts, of generally no more than 140-160 characters in length to be sent and transmitted from the mobile computing device. SMS was introduced in a Global System for Mobile Communications (GSM) system and later supported by many other digital-based mobile communications systems. Unlike paging, but similar to e-mail, alerts are typically stored and forwarded at SMS servers, which allows the mobile computing device to retrieve the short message at some later time.

Because SMS messages, alerts, are constrained in length, however, they may provide limited flexibility. Often, an SMS message header may consume most, if not all, of the 140-160 characters, resulting in an inability to provide a complete message to a recipient. Thus, there is a need in the industry to enable more flexible messaging. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a server device that may be included in a system implementing the invention;

FIG. 3 illustrates a logical flow diagram generally showing one embodiment for a process of registering a mobile device to receive a simplified access to an alert;

FIG. 4 illustrates a logical flow diagram generally showing one embodiment for a process of managing simplified access to the alert for the mobile device; and

FIG. 5 illustrates one embodiment of logical data flows in another environment for practicing the invention, in accordance with the present invention.

### DETAILED DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

The terms “comprising,” “including,” “containing,” “having,” and “characterized by,” refer to an open-ended or inclusive transitional construct and does not exclude additional, unrecited elements, or method steps. For example, a combination that comprises A and B elements, also reads on a combination of A, B, and C elements.

The meaning of “a,” “an,” and “the” include plural references. The meaning of “in” includes “in” and “on.” Additionally, a reference to the singular includes a reference to the plural unless otherwise stated or is inconsistent with the disclosure herein.

The term “or” is an inclusive “or” operator, and includes the term “and/or,” unless the context clearly dictates otherwise.

The phrase “in one embodiment,” as used herein does not necessarily refer to the same embodiment, although it may.

The term “based on” is not exclusive and provides for being based on additional factors not described, unless the context clearly dictates otherwise.

Briefly stated, the present invention is directed towards a client, server, and method for enabling simplified access to an alert by a mobile device. The mobile device is registered with a server for receiving the alert. Registration may include providing a phone number, device identifier, information associated with a carrier, and the like, to the server, and receiving a confirmation message in response. The server employs the device identifier, and the like, to authentic the mobile device, end-user, and the like, and to associate the device identifier to a user account identifier, and the like, that may then be stored in a registration store.

Upon successful registration, the mobile device may receive a short message, such as an SMS message, MMS message and the like. The short message may comprise a message hook, such as a Uniform Resource Locator (URL), a script, an executable script, program, and the like, that enables access to another message. The message hook may further include a message index usable to locate and access the other message. Upon selection of the message hook, the server forwards the other message in a format that is readable from a mobile browser, and the like. In one embodiment, the other message is an email message that is formatted in a Wireless Application Protocol (WAP) format, and the like. In another embodiment, the formatted message includes another message hook, including another message index, which is associated with an attachment message. The attachment message may also be formatted to be readable by the mobile browser, and the like.

Illustrative Operating Environment

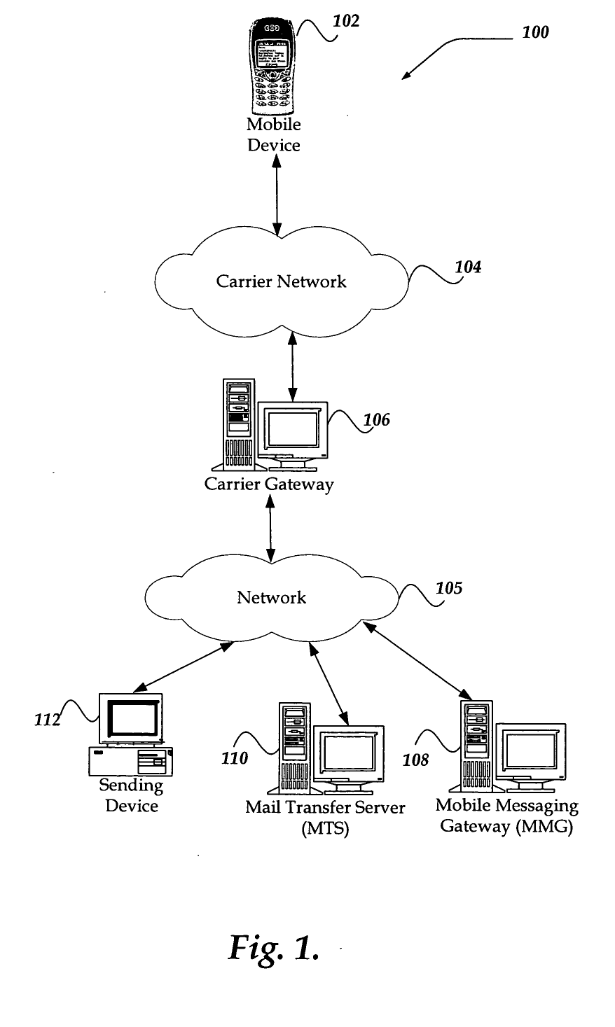

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, system 100 includes mobile device 102, carrier network 104, carrier gateway 106, network 105, Mobile Messaging Gateway (MMG) 108, Mail Transfer Server (MTS) 110, and sending device 112. Carrier network 104 is in communication with mobile device 102 and carrier network 106. Network 105 is in communication with and enables communication between carrier gateway 106, MMG 108, MTS 1110, and sending device 112.

Generally, mobile device 102 may include virtually any portable computing device capable of connecting to another computing device to send and receive a message. Such devices include cellular telephones, smart phones, display pagers, radio frequency (RF) devices, infrared (IR) devices, integrated devices combining one or more of the preceding devices, and the like. Mobile device 102 may also include other devices, such as Personal Digital Assistants (PDAs), microprocessor-based or programmable consumer electronics, wearable computers, and the like. As such, mobile devices typically range widely in terms of capabilities and features. For example, a web-enabled mobile device may have a touch sensitive screen, a stylus, and several lines of color LCD display in which both text and graphics may be displayed. Moreover, the web-enabled mobile device may include a mobile browser application enabled to receive and to send wireless application protocol messages (WAP), and the like. In one embodiment, the mobile browser application is enabled to employ a Handheld Device Markup Language (HDML), such as Wireless Markup Language (WML), WMLScript, JavaScript, and the like, to display and send a message.

Mobile device 102 may include a keyboard, mouse, speakers, a microphone, and an area on which to display information. Mobile device 102 may further include low-end devices that may have limited storage memory, reduced application sets, low bandwidth for transmission of a communication, and the like.

Mobile device 102 may provide a message, network packet, and the like, that includes a device identifier, such as a Mobile Identification Number (MIN). A MIN may include a North American Numbering Plan (NANP) number that is configured to serve as a mobile telephone number for mobile device 102. MINs may be programmed into mobile device 102 at time of manufacture, purchase, and the like. Mobile device 102 is not limited to providing a MIN number as the device identifier, and another device identifier may also be provided, such as an electronic serial number (ESN), application serial number, and the like, without departing from the scope of the invention. Mobile device 102 may further provide a phone number in addition to the device identifier. In one embodiment, mobile device 102 includes a device identification component configured to provide the MIN, ESN, application serial number, phone number, and the like.

Mobile device 102 may be configured to receive a message, such as through a Short Message Service (SMS), Multimedia Message Service (MMS), and the like, from the other computing device, such as MMG 108, and the like. In one embodiment, the message includes a message hook, such as a URL, script, program, and the like. Mobile device 102 may be further configured to employ the message hook to request access to another message, such as from MMG 108, MTS 110, a mail farm (not shown) comprising of at least on server, and the like. In one embodiment, the other message is an email message. However, the present invention is not limited to email messages, and virtually any other message type, and the like, may be accessible through the included message hook. For example, the message may include, but not be limited to, a document, an audio file, a graphics file including but not limited to a bitmap file, a jpeg file, and the like, a video file, a File Transfer Protocol command, a compressed file, and the like.

Mobile device 102 may further include a client application, and the like, that is configured to manage the actions described above for mobile device 102.

Carrier network 104 is configured to couple mobile device 102 and its components with carrier gateway 106. Carrier network 104 may include any of a variety of wireless sub-networks that may further overlay stand-alone ad-hoc networks, and the like, to provide an infrastructure-oriented connection for mobile device 102. Such sub-networks may include mesh networks, Wireless LAN (WLAN) networks, cellular networks, and the like.

Carrier network 104 may further include an autonomous system of terminals, gateways, routers, and the like connected by wireless radio links, and the like.

These connectors may be configured to move freely and randomly and organize themselves arbitrarily, such that the topology of carrier network 104 may change rapidly.

Carrier network 104 may further employ a plurality of access technologies including, but not limited to, 2nd (2G), 3rd (3G) generation radio access for cellular systems, WLAN, Wireless Router (WR) mesh, and the like. Access technologies such as 2G, 3G, and future access networks may enable wide area coverage for mobile devices, such as mobile device 102 with various degrees of mobility. For example, carrier network 104 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, carrier network 104 may include virtually any wireless communication mechanism by which information may travel between mobile device 102 and carrier gateway 106.

Carrier gateway 106 may include any computing device capable of connecting with mobile device 102 to enable communications with another computing device, such as MMG 108, MTS 110, sending device 112, another mobile device (not shown), and the like. Such devices that may operate as carrier gateway 106 include, but are not limited to, personal computers, desktop computers, multiprocessor systems, microprocessor-based or programmable consumer electronics, network PCs, servers, and the like.

Carrier gateway 106 typically includes a carrier level service provider's computing device, and related infrastructure. Carrier gateway 106 may be configured to receive a network packet, and the like, from mobile device 102. The network packet, and the like, may include information associated with mobile device 102, such as a device identifier, and the like. The network packet may further include information associated with an end-user of mobile device 102, such as a user account identifier (YID), and the like. Carrier gateway 106 may include additional information in the network packet prior to sending the network packet towards another device, such as MMG 108, MTS 110, and the like. The additional information may include carrier information including, but not limited to, a carrier gateway grouping, carrier type, carrier identifier, and the like.

Carrier gateway 106 may further receive a network packet from MTS 110, MMG 108, sending device 112, and the like. The received network packet may include an SMS message, a mobile browser readable message, and the like.

Network 105 is configured to couple MMG 108, MTS 110, sending device 112, and the like, with carrier gateway 106. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between carrier gateway 106, MMG 108, MTS 110, sending device 112, and the like.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

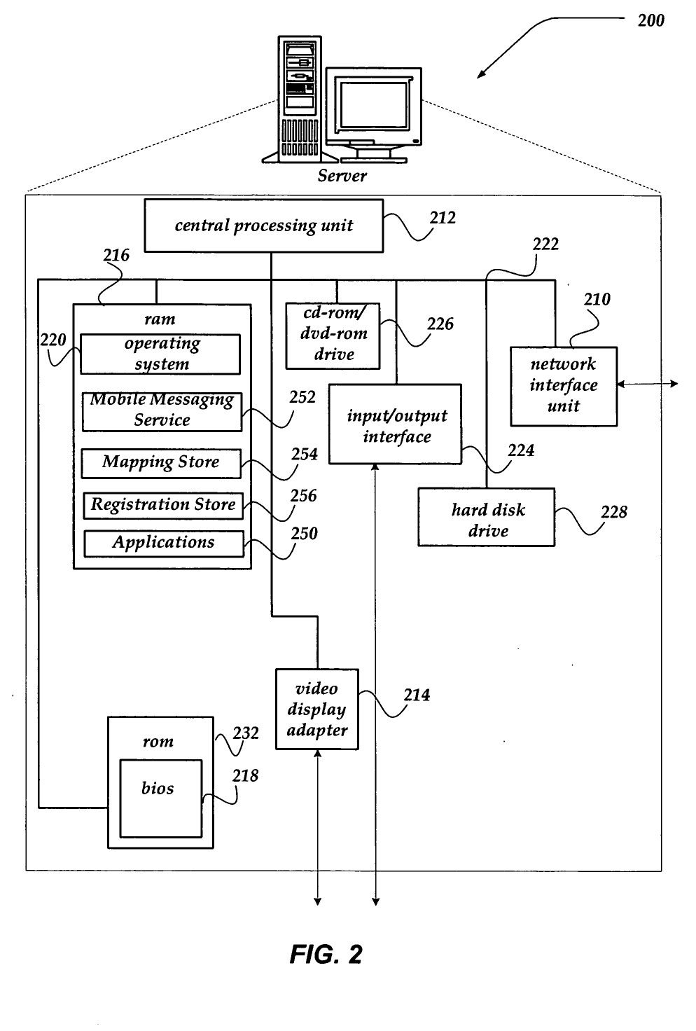

One embodiment of MMG 108 is described in more detail below in conjunction with FIG. 2. Briefly, however, MMG 108 may include any computing device capable of communicating with mobile device 102. Such devices include personal computers, desktop computers, multiprocessor systems, microprocessor-based or programmable consumer electronics, network PCs, servers, and the like.

MMG 108 may be configured to perform actions directed to register mobile device 102. MMG 108 may receive registration information from mobile device 102, and store the registration information in a registration store (not shown). The registration store may include a database, a text file, a folder, and the like, configured to maintain the registration information. Such registration information may include, but is not limited to a YID, a mobile device phone number, information associated with carrier gateway 106, device identifier such as a MIN, and the like.

MMG 108 may be further configured to receive a message notification associated with a message from MTS 110. In response, MMG 108 may format a short message, such as a SMS message, MMS message, or the like, and send the formatted message towards mobile device 102. MMG 108 may employ the registration information from the registration store, along with information associated with the message notification, a universal message identifier, and the like to format the short message. In one embodiment, the short message includes a Uniform Resource Locator (URL). In another embodiment, the short message is a SMS message that includes the URL.

The message hook may further include a message index associated with other message. MMG 108 may determine the message index based, in part, on information received from MTS 110, including, but not limited to, the universal message identifier that points to a storage location for the message. The message index may be generated to map a relationship between the universal message identifier and the device identifier, based on any of a variety of mechanisms, including, but not limited to a counter, a one-way hash, and the like. MMG 108 may employ a mapping store (not shown) to save the mapping, including the message index, universal message identifier, and the device identifier.

MTS 110 may include any computing device capable of connecting to mobile device 102, MMG 108, and the like, to send and receive a message, message notification, and the like. Such devices include personal computers, desktop computers, multiprocessor systems, microprocessor-based or programmable consumer electronics, network PCs, servers, and the like.

MTS 110 may be configured to receive the message, for example, from sending device 112. MTS 110 may determine whether the intended recipient of the message is configured to receive the message in a mobile browser readable format.

MTS 110 may employ the end-user account identifier (YID), device identifier, phone number, and the like, to determine whether the intended recipient is configured to receive the message in a mobile browser readable format. If the intended recipient is configured to receive the message in a mobile browser readable format, MTS 110 may provide a mobile alert message, such as a message notification, to MMG 108. MTS 110 may further associate meta-information with the message notification, including a YID, universal message identifier, and the like.

MTS 110 may store the other message at a location that may be determined based, in part, on at least one of the YID, universal message identifier, device identifier, and the like. In one embodiment, MMG 1018 may store the other message in at a server that may be one of a plurality of servers in a mail farm (not shown), or the like.

Although MMG 108 and MTS 110 are illustrated as distinct computing devices, the present invention is not so limited. For example, the functionality of MMG 108 and MTS 110 may be associated with a single computing device, or spread across multiple computing devices, without departing from the scope of the invention.

Sending device 112 represents virtually any device enabled to send a message to another computing device, including but not limited to MTS 110, MMG 108, Carrier Gateway 106, and mobile device 102. Such devices include personal computers, desktop computers, multiprocessor systems, microprocessor-based or programmable consumer electronics, network PCs, servers, and the like.

Illustrative Server Environment

FIG. 2 shows one embodiment of a server, according to one embodiment of the invention. Server 200 may include many more components than those shown. The components shown, however, are sufficient to disclose an illustrative embodiment for practicing the invention. Server 200 may represent, for example, MMG 108 of FIG. 1.

Server 200 includes processing unit 212, video display adapter 214, and a mass memory, all in communication with each other via bus 222. The mass memory generally includes RAM 216, ROM 232, and one or more permanent mass storage devices, such as hard disk drive 228, tape drive, optical drive, and/or floppy disk drive. The mass memory stores operating system 220 for controlling the operation of server 102. Any general-purpose operating system may be employed. Basic input/output system (“BIOS”) 218 is also provided for controlling the low-level operation of server 102. As illustrated in FIG. 2, server 200 also can communicate with the Internet, or some other communications network, such as network 105 in FIG. 1, via network interface unit 210, which is constructed for use with various communication protocols including the TCP/IP protocol. Network interface unit 210 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 250 are loaded into mass memory and run on operating system 220. Examples of application programs include mail programs, transcoder, schedulers, calendars, database programs, word processing programs, HTTP programs, HDML programs, SMS programs, MMS programs, spreadsheet programs, and so forth. Mass storage may further include applications such as mobile messaging service 252, mapping store 254, and registration store 256.

Mobile messaging service 252 may be configured to manage the registration of a mobile device. Mobile messaging service 252 may store and retrieve registration information from registration store 256.

Mobile messaging service 252 may further receive a mobile alert message, such as a message notification, indicating that a mobile device is enabled to receive a mobile browser readable message, that a message is available for the mobile device, and the like. Mobile messaging service 252 may also receive meta information, such as a YID, universal message identifier, and the like. Mobile messaging service 252 may associate a message index with the universal message identifier, device identifier, MIN, YID, and the like. The message index may be determined based on any of a variety of mechanisms, including a counter, a one-way hash, and the like. The message index may then be stored in mapping store 254.

Mobile messaging service 252 may further format and provide a short message, such as an SMS message, an MMS message, and the like, to the mobile device associated with the other message. The short message may include a message hook that enables access to the other message. In one embodiment, the message hook is a URL that includes the message index.

Although illustrated in FIG. 2 as distinct components, mobile messaging service 252, mapping store 254, and registration store 256 may be arranged, combined, and the like, in any of a variety of ways, without departing from the scope of the present invention. Moreover, messaging service 252, mapping store 254, and registration store 256 may reside in one or more computing devices, substantially similar to server 200.

Server 200 may also include an SMTP handler application for transmitting and receiving e-mail, an HTTP handler application for receiving and handing HTTP requests, and an HTTPS handler application for handling secure connections. The HTTPS handler application may initiate communication with an external application in a secure fashion.

Server 200 also includes input/output interface 224 for communicating with external devices, such as a mouse, keyboard, scanner, or other input devices not shown in FIG. 2. Likewise, server 200 may further include additional mass storage facilities such as CD-ROM/DVD-ROM drive 226 and hard disk drive 228. Hard disk drive 228 may be utilized to store, among other things, application programs, databases, registration information, messages, and the like.

Generalized Operation

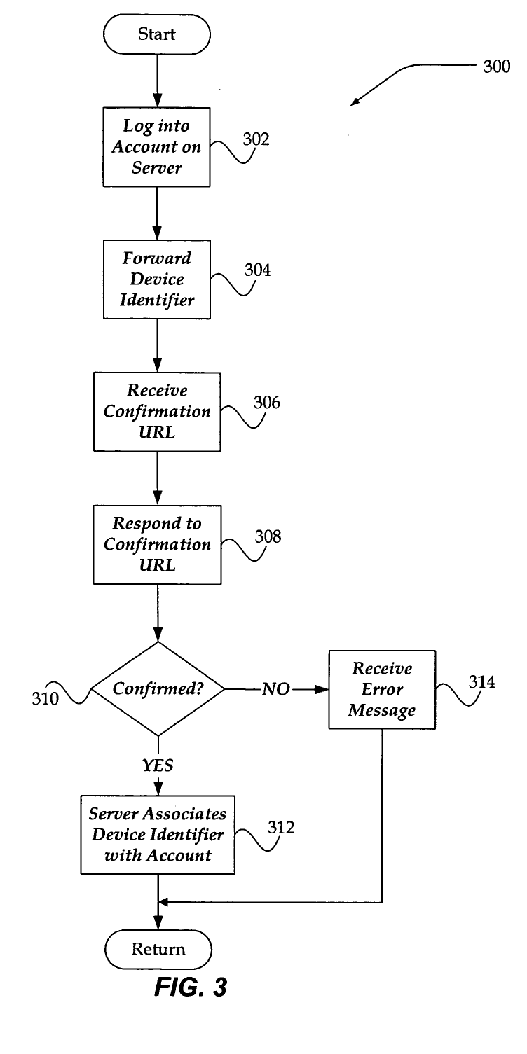

The operation of certain aspects of the present invention will now be described with respect to FIG. 3. FIG. 3 is a flow diagram generally showing one embodiment for a process of registering a mobile device to receive a simplified access to an alert. Registration process 300 may be implemented within MMG 108 of FIG. 1.

Registration process 300 begins, after a start block, at block 302, where a mobile device logs into an end-user account. In one embodiment, the end-user account is managed by a server such as MMG 108 of FIG. 1. For ease of understanding, registration process 300 employs an SMS message to represent a short message, and a URL to represent the message hook. However, the present invention is not so limited and virtually any messaging structure may be employed to provide the short message. Additionally, virtually any message hook may be employed to enable access to the other message, including a script, an executable script, a program, and the like.

Processing continues to block 304 where a device identifier associated with the mobile device is forwarded to the server. The device identifier may include a MIN, an ESN, a phone number, and the like. Processing next proceeds to block 306 where a confirmation SMS message is sent by the server to the mobile device associated with the phone number. In one embodiment, a URL and associated confirmation information is included in the confirmation SMS message.

Processing flows next to block 308, where the end-user completes the registration process, in part, by responding to the URL within the confirmation SMS message.

Processing next continues to decision block 310, where a determination is made whether the confirmation response is from the mobile device associated with the device identifier. In one embodiment, the device identifier is sent to the server, with an HTTP request from the mobile device. In any event, if it is determined that the mobile device is confirmed, processing flows to block 312; otherwise processing flows to block 314.

At block 314, an error message is received by the mobile device indicating that confirmation to receive simplified message alerts is denied. Confirmation may be denied for a variety of reasons, including, but not limited to, incorrect device identifier, the mobile device is not configured to receive mobile browser readable messages, a user account identifier was not located, and the like. In any event, upon receiving the error message, registration process returns to a calling process to perform other actions.

At block 312, if the mobile device is confirmed, the server associates the device identifier with the user account identifier, carrier information, and the like. Upon a completion of the registration, the server is configured to provide simplified access to message alerts to the mobile device. Processing then returns to a calling process to perform other actions.

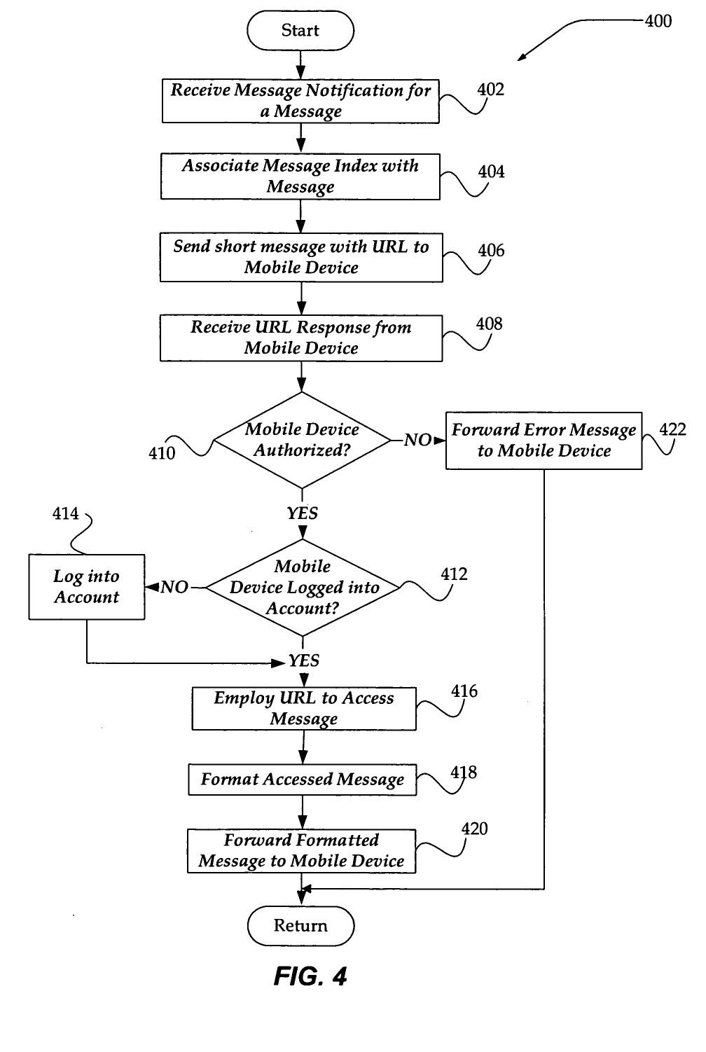

FIG. 4 illustrates a logical flow diagram generally showing one embodiment for a process of managing a simplified access to the alert for the mobile device. Process 400 may be implemented within MMG 108 of FIG. 1.

For ease of understanding, process 400 employs an SMS message to represent a short message, and a URL to represent the message hook. However, the present invention is not so limited and virtually any messaging structure may be employed to provide the short message. Additionally, virtually any message hook may be employed to access the other message, including a script, an executable script, program, and the like.

Process 400 begins, after a start block, at block 402, where a message notification for a message is received. In one embodiment, the message notification is received by MMG 108 from another computing device, such as MTS 110 of FIG. 1. In one embodiment, the message notification is a mobile alert message with associated meta-information that may include a universal message identifier, a YID, and the like.

Processing continues next to block 404 where a message index is associated with a stored location of the message. In one embodiment, the message index employs the universal message identifier, in part, to generate a mapping between the universal message identifier, device identifier, and the like. The message index may be generated employing any of a variety of mechanisms, including, but not limited to, a counter, a one-way hash, and the like. The message index may then be stored in a mapping store, or the like, and be keyed by the device identifier, or the like.

Processing continues to block 406 where a short message, such as an SMS message is generated. The short message may include a message hook. In one embodiment, the SMS message includes a URL as the message hook. In another embodiment, the URL is of the form of http://wap.oa.yahoo.com/raw?dp=sc&n=1, where n represents the value of the message index. The SMS message may then be sent to the appropriate mobile device.

Processing flows next to block 408, where the mobile device responds to the URL. In one embodiment, the end-user of the mobile device selects and clicks on the URL to send a response to the server. In another embodiment, the device identifier, phone number, and the like, is also sent to the server.

Upon receiving the URL response, device identifier, and the like, the process flows to decision block 410, where a determination is made whether the URL response is from an authorized mobile device. Authorization may be determined based in part on a variety of mechanisms, including but not limited to comparing the received device identifier, with a device identifier associated with the valid YID, valid device identifier, MIN, phone number, carrier information, and the like. In any event, if it is determined that the URL response is from an authorized mobile device, processing continues to decision block 412; otherwise, processing branches to block 422, where an error message is forwarded to the mobile device. Upon completion of block 422, processing returns to a calling process to perform other actions.

At decision block 412, a determination is made whether the mobile device is logged into the user account associated with the message of block 402. If it is determined that the mobile device is logged into the appropriate user account processing continues to block 416. If the mobile device is not logged into the appropriate user account, processing continues to block 414, where a log in procedure is performed that is intended to result in the mobile device being logged into the appropriate and authorized user account. Processing continues from block 414 to block 416.

At block 416, the URL response is employed to access the stored message. In one embodiment, the message index associated with the URL response, and the device identifier, may also be employed to locate the universal message identifier associated with the stored message. The located universal message identifier may then be employed to access the stored message.

Processing continues next to block 418, where the accessed message is formatted to be readable by a mobile browser. Such format may include any of a variety of HDML formats, and the like, including, but not limited to WML, and the like.

Processing then flows to block 420, where the formatted message may be forwarded to the mobile device. Upon completion of block 420, processing returns to a calling process to perform other actions.

Although the above process describes storing the formatted received message, the invention is not so limited. For example, the original message (and any associated attachment message) may be stored and formatted into a mobile browser readable format at virtually any time prior to forwarding them to the mobile device.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

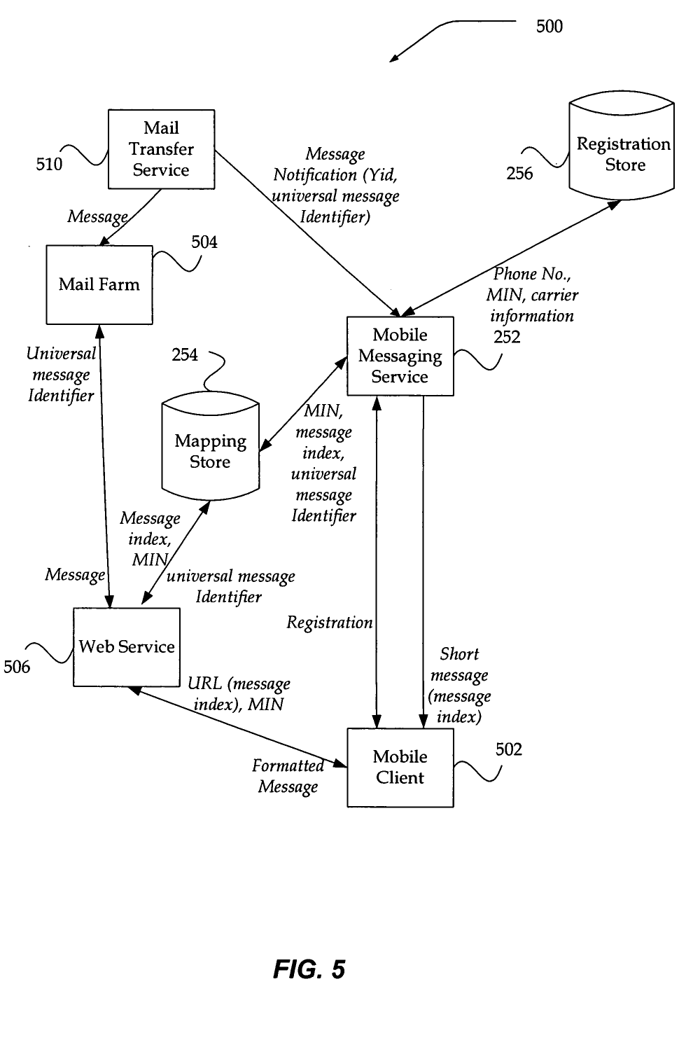

FIG. 5 illustrates one embodiment of logical data flows in another environment for practicing the invention, in accordance with the present invention. Flows 500 may include many more, or less, components than those shown. The components shown, however, are sufficient to disclose an illustrative embodiment for practicing the invention. Although FIG. 5 illustrates use of a URL and an SMS message, the invention is not so limited, and another message hook and short message mechanism may be employed, without departing from the scope of the invention.

As shown in the figure, flows 500 includes registration store 256, mobile messaging service 252, mobile client 502, web service 506, mapping store 254, and mail farm 504. Mobile messaging service 252 is in communication with registration store 256, mail transfer service 510, mobile client 502, and mapping store 254. Mail farm 504 is in communication with web service 506. Web service 506 is also in communication with mobile client 502, and mapping store 254.

Web services 506 may operate as a component within MMG 108 of FIG. 1, or operate within another computing device, or as a combination of MMG 108 and the other computing device. Mapping store 254, registration store 256, and mobile messaging service 252 are described above, in conjunction with FIG. 2.

FIG. 5 illustrates logical components that may be enabled to communicate a simplified message alert to mobile client 502. As such, mobile client 502 may communicate with mobile messaging service 252 to perform registration actions, substantially similar to those described above in FIG. 3. Mobile messaging service 252 may store the YID associated with an end-user of mobile client 502, a phone number, a device identifier, carrier information, and the like, in registration store 256.

Mail transfer service 510 may receive a message from a variety of sources (not shown). In one embodiment, mail transfer service 510 is enabled to employ a mobile alert filter to determine if a destined mobile client, such as mobile client 502, is enabled to receive the message. If the mobile client is enabled to receive the message, mail transfer service 510 may send a message notification, along with the associated YID, universal message identifier, and the like, to mobile messaging service 252.

Mail transfer service 510 may employ the YID, universal message identifier, and the like to store the message and any associated attachment message to the message, in mail farm 504.

Mobile messaging service 252 may receive the message notification from mail transfer service 510, along with the YID, universal message identifier and the like. Mobile messaging service 252 may employ registration store 256 to locate device information for the message, including a phone number, device identifier, carrier information, and the like.

Mobile message service 252 may employ the universal message identifier, device identifier, and the like to generate a message index that maps the universal message identifier associated with the location of the stored message to the device identifier, phone number, and the like.

Mobile messaging service 252 may then generate a short message, such as an SMS message, and the like, that includes a message hook, such as a URL. The short message, including the message hook, message index, and the like, may then be sent to mobile client 502, substantially similar to that described above in conjunction with FIG. 4.

Mobile client 502 may send a URL response message to web service 506, where the URL response includes at least the message index to the stored message. Mobile client 502 may further send its device identifier to web service 506.

Web service 506 may receive the URL response and associated information. Web service 506 may employ the associated information, including the message index, device identifier, and the like, to access the universal message identifier stored in mapping store 254. Web service 506 may then employ the universal message identifier to retrieve the message from mail farm 504. Web service 506 may also retrieve any associated attachment messages from mail farm 504. Web service 506 may format the message and associated attachment messages into a mobile browser readable format, and provide the formatted message to mobile client 502.

The above specification, examples, and data provide a complete description of the manufacture and use of the composition of the invention. Since many embodiments of the invention can be made without departing from the spirit and scope of the invention, the invention resides in the claims hereinafter appended.

1. A method of managing a communication with a mobile device over a network, comprising:
receiving a first message;
sending a second message to the mobile device, wherein the second message includes a message hook;
employing the message hook to access the first message;
formatting the first message to be readable by a mobile browser; and
sending the formatted first message towards the mobile browser.

2. The method of claim 1, wherein formatting the first message further comprises formatting the message using at least one of a Handheld Device Markup Language (HDML), Wireless Markup Language (WML)Script, and JavaScript.

3. The method of claim 1, wherein sending the second message further comprises:
associating a message index with the first message;
associating the message index with the second message; and
sending the second message including the associated message index to the mobile device, wherein the message index is usable to locate the first message.

4. The method of claim 3, wherein associating the message index with the first message further comprises employing a one way hash.

5. The method of claim 1, wherein the first message is stored in a mail farm.

6. The method of claim 1, wherein receiving the first message further comprises receiving at least one of a user account identifier, and a universal message identifier associated with the first message.

7. The method of claim 1, wherein the message hook further comprises at least one of a Uniform Resource Locator (URL), a script, and an executable program.

8. The method of claim 1, wherein the message hook further comprises a message index associated with the message, and a URL.

9. The method of claim 1, wherein the second message further comprises at least one of an SMS message, and an MMS message.

10. The method of claim 1, wherein the second message further comprises a message index associated with the message, wherein the message index is employable to locate the message.

11. The method of claim 1, receiving the first message further comprises:
receiving the first message by a mail transfer service;
storing the first message at a mail farm by the mail transfer service; and
associating a universal message identifier with the location of the stored first message.

12. The method of claim 1, further comprising:
logging into an account at a server through the mobile device;
forwarding a device identifier associated with the mobile device to the server;
receiving at the mobile device a confirmation URL from the server;
responding to the confirmation URL; and
if the mobile device is confirmed, registering the mobile device to receive the formatted first message.

13. The method of claim 12, wherein registering the mobile device further comprises associating the device identifier with the account.

14. The method of claim 1, wherein the first message is an email message.

15. The method of claim 1, wherein the first message further comprises an email message and an attachment to the email message.

16. A client adapted for use in a mobile device to receive messages from a server over a network, the client being configured to perform actions, comprising:
receiving a first message from the server, wherein the first message includes a message hook;
employing the message hook to access the second message, wherein the second message is formatted to be readable from a mobile browser.

17. The client of claim 16, wherein the formatted second message is formatted using at least one of a Handheld Device Markup Language (HDML), Wireless Markup Language (WML) Script, and JavaScript.

18. The client of claim 16, wherein the message hook further comprises a Uniform Resource Locator (URL).

19. The client of claim 18, wherein the URL further comprises a message index associated with the second message.

20. The client of claim 16, wherein the first message further comprises at least one of an SMS message, and a MMS message.

21. The client of claim 16, wherein the message hook further comprises a message index associated with the second message, wherein the message index is employable to access the second message.

22. The client of claim 16, wherein the second message further comprises at least one of an email message, an email attachment message, a document, an audio file, a graphics file, and a video file.

23. A server for managing a communication with a mobile device over a network, comprising:
a transceiver for receiving and sending messages to the mobile device; and
a transcoder that is configured to perform actions, including:
receiving an alert indicating a first message is available for the mobile device;
forwarding a second message to the mobile device, wherein the second message includes a message hook;
receiving a response to the second message from the mobile device, including the message hook;
employing the message hook to enable access to the first message;
formatting the first message to be readable from a mobile browser; and
sending the formatted first message towards the mobile browser.

24. The server of claim 23, wherein the first message further comprises at least one of an email message, an email attachment message, a document, an audio file, a graphics file, and a video. file.

25. The server of claim 23, wherein the message hook further comprises at least one of a Uniform Resource Locator (URL), a script, and an executable program.

26. The server of claim 23, wherein the second message further comprises at least one of an SMS message, and an MMS message.

27. The server of claim 23, wherein the message hook further comprises a message index associated with the first message, wherein the message index is employable to locate the first message.

28. The server of claim 23, wherein formatting the first message further comprises using a Wireless Markup Language (WML).

29. A modulated data signal for communicating with a mobile device, the modulated data signal comprising the actions of:
receiving an alert indicating a first message is available for the mobile device;
sending a second message to the mobile device, wherein the second message includes a message hook; and
employing the message hook to access the first message, wherein the first message is formatted to be readable by a mobile browser.

30. The modulated data signal of claim 29, wherein the first message further comprises an email message.

31. The modulated data signal of claim 29, wherein the message hook further comprises at least one of a Uniform Resource Locator (URL), a script, and an executable program.

32. The modulated data signal of claim 29, wherein the second message further comprises at least one of an SMS message, and an MMS message.

33. The modulated data signal of claim 29, wherein the message hook further comprises a URL that includes a message index associated with the first message, wherein the message index is employable to locate the first message.

34. A system for communicating messages to a mobile device over a network, comprising:
a mail transfer service configured to receive a first message and to provide an alert indicating receipt of the first message;
a mobile messaging service, coupled to the mail transfer service and the mobile device, that is configured to perform actions, including:
receiving the alert from the mail transfer service;
associating a message hook with the first message;
sending a second message to the mobile device, wherein the second message includes the message hook;
a web service, coupled to the mobile messaging service, that is configured to perform actions, including:
receiving a response to the second message from the mobile device, wherein the response employs the message hook;
retrieving the first message;
formatting the first message to be readable by a mobile browser; and
sending the formatted first message towards the mobile browser.

35. The system of claim 34, wherein formatting the first message further comprises formatting the message using at least one of a Handheld Device Markup Language (HDML), Wireless Markup Language (WML) Script, and JavaScript.

36. The system of claim 34, wherein the message hook further comprises at least one of a Uniform Resource Locator (URL), a script, and an executable program.

37. The system of claim 34, wherein the message hook further comprises a message index.

38. The system of claim 37, wherein the message index further comprises a mapping between a universal message identifier and a device identifier.

39. The system of claim 34, wherein retrieving the first message further comprises:
determining a message index associated with the message hook, and a device identifier;
employing the message index to access a universal message identifier; and
employing the universal message identifier to retrieve the first message.

40. An apparatus for communicating with a mobile device, comprising:
a means for receiving a first message;
a means for sending a second message to the mobile device, wherein the second message includes a message hook means;
a means for employing the message hook means to access the first message;
a means for formatting the first message to be readable by a mobile browser; and
a means for forwarding the formatted first message towards the mobile browser.

41. The apparatus of claim 40, wherein the message hook means further comprises a URL and a means for identifying the first message.
